(19) United States
(12) Patent Application Publication
(10) Pub. No.: US 2025/0189639 A1
(43) Pub. Date: Jun. 12, 2025

(54) PROXIMITY SENSING DEVICE

(71) Applicant: STMicroelectronics International N.V., Geneva (CH)

(72) Inventors: Charlotte Milanetto, Grenoble (FR); Christophe Premont, Noyarey (FR)

(21) Appl. No.: 18/951,179

(22) Filed: Nov. 18, 2024

(30) Foreign Application Priority Data
Dec. 6, 2023 (FR) FR2313616

(51) Int. Cl. G01S 7/487; G01S 7/481; G01S 7/4865; G01S 7/51; G01S 17/10

(52) U.S. Cl. CPC G01S 7/4873; G01S 7/4814; G01S 7/4816; G01S 7/4865; G01S 7/51; G01S 17/10

(57) ABSTRACT

The present disclosure relates to a proximity capture device that includes a proximity sensor having a light source and a light detector. The light detector includes at least one first photodiode configured to generate a first signal when it detects a first light signal emitted by the light source and reflected by an object and one second photodiode configured to generate a second signal when it detects a second light signal emitted by the light source and reflected by the object. The proximity sensor is configured to deliver an output signal based on weighting, with a weighting coefficient, the first signal differently from the second signal. The proximity capture device includes a control circuit configured to provide the weighting coefficient to the proximity sensor and receive the output signal, and to trigger from a first state in which the weighting coefficient has a first value, to a second state when the output signal crosses a first threshold; in the second state, apply to the weighting coefficient a second value different from the first value; and compare the output signal obtained by applying the second value and a second threshold so as to trigger from the second state to a third state if the output signal is less than the second threshold, or to trigger from the second state to a fourth state if the output signal is higher than the second threshold.

### CROSS-REFERENCE TO RELATED APPLICATIONS

This application claims priority to French Application No. 2313616, filed on Dec. 6, 2023, which application is hereby incorporated herein by reference.

### TECHNICAL FIELD

The present description relates generally to electronic devices, more particularly to electronic devices comprising a proximity sensor, for example a proximity sensor arranged under a display screen.

### BACKGROUND

A proximity sensor generally comprises a light source and a light detector. The general principle of a proximity sensor is that the source emits a light beam, for example an infrared beam, being reflected by an object and picked up in return by the detector. The detector may comprise one or more photodiodes. The proximity sensor may be coupled to, or comprise, a processing unit, configured to process a signal from the detector, for a proximity detection calculation. For example, the signal may have a value, such as an amplitude or a number of pulses, which varies as a function of the distance from the object to the detector, and the processing unit may process this signal to deduce the presence or absence of an object in the vicinity of a proximity sensor.

The proximity sensor can be a sensor of the time-of-flight (ToF) type, in which case the processing unit can be configured to calculate the travel time between the emission of the light beam and its reception by the detector, and the distance from the object to the proximity sensor can then be deduced based on this travel time.

Electronic devices are known which include a proximity sensor arranged beneath a screen, such as a display screen. The display screen may be a screen of the organic light-emitting diode (OLED) type. A proximity sensor under the display screen of a smartphone can be used to detect the presence of a user against the screen, for example when he or she sticks an ear to the screen to make a phone call, which can cause the screen to turn off. The proximity sensor can detect if the user moves away from the screen, causing the screen to turn back on.

It has been found that, when a proximity sensor is positioned under a low light transmittance screen, for example an OLED-type display screen, the proximity sensor could fail to distinguish whether the object is at a very short distance (very close object), typically a few millimeters, for example less than 2 or 3 millimeters, or at a long distance (distant object), typically more than a few centimeters, for example more than 20, 30, or even 40 millimeters, from said sensor. In the example of the user and the smartphone described above, this could compromise switching off the display screen when the user is very close to the screen and/or switching on the screen again when he or she moves away from the screen.

### SUMMARY

There is a need for an electronic device, comprising at least one display screen and a proximity sensor under the display screen, more generally under a wall with low light transmittance, capable of determining whether an object is at a very short or long distance.

Also sought is a proximity capture device, i.e. a device comprising a proximity sensor, capable of determining whether an object is at a very short or long distance with an easy-to-implement solution.

One embodiment may overcome some or all of the drawbacks of known proximity sensors.

One embodiment provides a proximity capture device comprising: a proximity sensor comprising a light source and a light detector including at least one first photodiode adapted to generate a first signal when it detects a first light signal emitted by the light source and reflected by an object, and one second photodiode adapted to generate a second signal when it detects a second light signal emitted by the light source and reflected by the object; the proximity sensor being adapted to deliver an output signal according to the first and second signals, by weighting one of the first and second signals with a weighting coefficient; and a control circuit adapted to receive the output signal, and to: trigger from a first state, in which the weighting coefficient has a first value, to a second state when the output signal crosses a first threshold; in the second state, apply to the weighting coefficient a second value different from the first value; and compare the output signal obtained by applying the second value and a second threshold so as to trigger from the second state to a third state if the output signal is less than the second threshold, or to trigger from the second state to a fourth state if the output signal is higher than the second threshold.

One embodiment provides a method of processing an output signal delivered by a proximity sensor comprising a light source and a light detector including at least one first photodiode adapted to generate a first signal when it detects a first light signal emitted by the light source and reflected by an object, and one second photodiode adapted to generate a second signal when it detects a second light signal emitted by the light source and reflected by the object; the output signal being determined according to the first and second signals, by weighting one of the first and second signals with a weighting coefficient; the method comprising transferring the output signal to a control circuit, which: triggers from a first state in which the weighting coefficient has a first value, to a second state when the output signal crosses a first threshold; in the second state, applies to the weighting coefficient a second value different from the first value; and compares the output signal obtained by applying the second value and a second threshold so as to trigger from the second state to a third state if the output signal is less than the second threshold, or to trigger from the second state to a fourth state if the output signal is higher than the second threshold.

According to one embodiment, the third state corresponds to a first distance from the object to the proximity sensor, and the fourth state corresponds to a second distance from the object to the proximity sensor, the second distance being higher than the first distance, or the first distance being higher than the second distance.

According to one embodiment, the output signal is obtained by subtracting the other one among the first and second signals from the signal weighted by the weighting coefficient. In other words, one of the first and second signals is weighted by the weighting coefficient, forming the signal weighted by the weighting coefficient, the other one among the first and second signals is not weighted by the weighting coefficient, and is subtracted from the signal weighted by the weighting coefficient.

According to one embodiment, the output signal is preprocessed by a processing device of the proximity sensor, the processing device being coupled with the control circuit.

According to one embodiment, the light source and the light sensor are located under a capping wall of the proximity sensor.

According to one embodiment, the first and second photodiodes are disposed side by side, and spaced apart by a distance, along a direction sensibly parallel to the plane of the capping wall.

According to one embodiment, the capping wall includes a first opening located in line with the light source, and a second opening in line with the light detector, for example the second opening is centered on the first photodiode, the second photodiode being located sensibly under a non-opened part of the capping wall.

According to one embodiment, the first photodiode is located between the light source and the second photodiode.

According to one embodiment, the proximity sensor is under a wall being able to generate a crosstalk phenomenon by reflecting on said wall light signals emitted by the light source then transferred towards the light detector, for example the wall has a light transmission coefficient less than 5% at the working wavelengths of the proximity sensor.

According to one embodiment, the control circuit is adapted to generate a state signal, the state signal comprising a first value in the third state and a second value in the fourth state.

According to one embodiment, the wall is a display screen, for example an OLED-type display screen, and the state signal is adapted to be transferred to the display screen, or to a control circuit of said display screen, so as to control its switching off or on, according to whether the state signal takes the first value or the second value.

According to one embodiment, the control circuit generates a state signal, the state signal comprising a first value in the third state and a second value in the fourth state.

According to one embodiment, the wall is a display screen, for example an OLED-type display screen, and the state signal is transferred to the display screen, or to a control circuit of said display screen, so as to control its switching off or on, according to whether the state signal takes the first value or the second value.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates a proximity sensor included in an electronic device and positioned under a display screen of the electronic device, and illustrates an operating mode of such a proximity sensor;

FIG. 2A and FIG. 2B illustrate an application of a proximity sensor in switching a display screen on or off;

FIG. 3 illustrates curves showing the evolution of signals generated by the photodiodes of the proximity sensor shown in FIG. 1 as a function of the distance from the proximity sensor to an object, and for several numbers of measurement samples;

FIG. 4 illustrates a proximity capture device according to one embodiment, included in an electronic device, and positioned under a display screen of the electronic device;

FIG. 5A illustrates an example embodiment of the control circuit for the proximity capture device shown in FIG. 4;

FIG. 5B illustrates an example of the operation of the control circuit shown in FIG. 5A; and

FIG. 6 illustrates a curve showing the evolution of the output signal from the proximity sensor shown in FIG. 4, and the different states of the control circuit shown in FIG. 5A as a function of the distance from the proximity sensor to an object.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, not all the components of an electronic device incorporating a proximity sensor under a display screen have been described in detail, the embodiments described being compatible with common electronic devices including a proximity sensor under a display screen. Similarly, not all the components of a proximity sensor have been detailed, as the embodiments described are compatible with common proximity sensors.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures, or to a proximity sensor as orientated during normal use.

Unless specified otherwise, the expressions “around”, “approximately”, “substantially” and “in the order of” signify within 10%, and preferably within 5%.

The light transmittance, or transmission coefficient, of an element is defined as the fraction of light intensity passing through it.

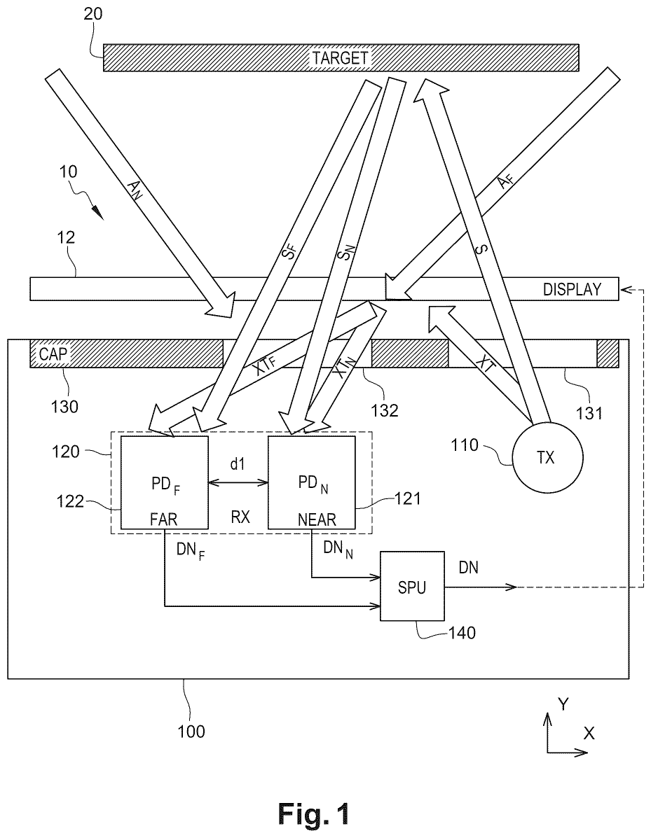

FIG. 1 illustrates a proximity sensor 100 included in an electronic device 10, and positioned under a display screen 12 (DISPLAY) of the electronic device, and illustrates an operating mode of such a sensor.

A proximity sensor 100 comprises a light source 110 (TX) and a light detector 120 (RX) located under a capping wall 130, for example a cap (CAP), which may correspond to a top wall of a housing containing the source and detector.

The source 110 may comprise a light-emitting diode (LED) or a vertical cavity surface emitting laser (VCSEL).

The detector 120 shown comprises two photodiodes, a first photodiode 121 (PD_{N}, NEAR) and a second photodiode 122 (PD_{F}, FAR). The two photodiodes 121, 122 are positioned so that the first photodiode 121 is closer to the source 110 than the second photodiode 122. For example, the first photodiode 121 is positioned between the source 110 and the second photodiode 122.

The wall 130 comprises two openings 131, 132, a first opening 131 in line with the source 110, and a second opening 132 in line with the detector 120, for example more particularly centered with the first photodiode 121, the second photodiode 122 being positioned substantially under an unopened portion of the wall 130.

Both first and second photodiodes 121, 122 are arranged side by side, and spaced apart by a first distance d1, in a direction X substantially parallel to the plane of the wall 130.

The photodiodes are adapted to detect a light signal emitted by the source 110 and then reflected by an object 20 (TARGET), and can be pinned photodiodes, avalanche photodiodes (APDs), or single photon avalanche detectors (SPADs).

The first photodiode 121 can be adapted to detect a nearby object in particular, while the second photodiode 122 can be adapted to detect a distant object in particular.

Furthermore, the electronic device 10 shown comprises a display screen 12, with the proximity sensor 100 arranged below this display screen. The display screen may be of the organic light-emitting diode (OLED) type. The wall 130 is positioned between the source/detector and the display screen 12, and the display screen 12 is positioned between the proximity sensor 100 and the object 20.

The proximity sensor 100 comprises a processing device 140 (SPU) configured to process the signals generated by the detector 120, in the example shown, the signals DN_{N}, DN_{F} from the photodiodes 121, 122, for a proximity detection calculation. The processing device 140 is configured to process the signals generated by the photodiodes, for example by implementing operations on these signals, and deliver an output signal DN of the proximity sensor 100.

For example, the output signal DN may have a value, e.g. a magnitude, a digital signal, e.g. a number of pulses or counts, which varies as a function of the distance from the object 20 to the detector 120, and the processing device 140 may process this signal, e.g. count the pulses, to deduce the presence or absence of an object in the vicinity of a proximity sensor.

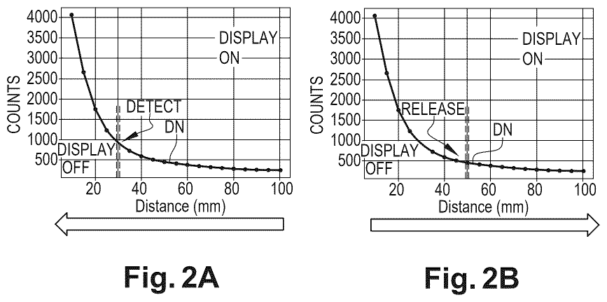

According to one application illustrated in FIGS. 2A and 2B, the output signal DN of the proximity sensor 100 can be transferred to the display screen 12 (DISPLAY), or to a display screen control circuit, in order to switch the display screen off (DISPLAY OFF) or on (DISPLAY ON). The display screen 12 may be a display screen of a cell phone, such as a smartphone, and comprise the proximity sensor 100 under the display screen 12, and the object 20 may be an organ, e.g. an ear, of a user of the cell phone.

In the example shown in FIGS. 2A and 2B, the value of the output signal DN increases as the object moves closer to the proximity sensor, i.e. as the distance from the object to the proximity sensor decreases (direction of arrow in FIG. 2A), and the value of the output signal DN decreases as the object moves away from the proximity sensor, i.e. as the distance from the object to the proximity sensor increases (direction of arrow in FIG. 2B).

If the value of the DN output signal rises above a detection threshold (DETECT) as the object moves closer to the proximity sensor, this may trigger the display to switch off (DISPLAY OFF), as shown in FIG. 2A. The display can remain off as long as the output signal value remains above a release threshold (RELEASE). The release threshold RELEASE is lower than the detection threshold DECTECT, as shown in FIG. 2B, to guarantee hysteresis, and for example to withstand different tolerances, such as electrical, optical and/or mechanical tolerances (sensor assembly, integration behind the display). The discrepancy between the detection threshold and the release threshold can be set to achieve stable hysteresis-type operation. If the value of the DN output signal falls below the release threshold RELEASE when the object moves away from the proximity sensor, this can trigger the display to switch on (DISPLAY ON), as shown in FIG. 2B.

One operating mode of the proximity sensor 100 is explained.

In operation, source 110 emits a light signal S through first opening 131 and screen 12. The light signal can be reflected by an object 20, and the reflected light signal can be received back by detector 120 through screen 12 and second opening 132. A first reflected light signal S_{N} can be detected by the first photodiode 121, and a second reflected light signal S_{F} can be detected by the first photodiode 122.

In addition to the reflected light signal s S_{N}, S_{F}, the first photodiode 121 detects a first signal A_{N} from ambient light (first ambient light signal), and the second photodiode 122 detects a second signal A_{F} from ambient light (second ambient light signal).

Moreover, it was found that the presence of an LED-type display screen, and more generally a screen or wall, with low light transmittance, typically less than 5% at the sensor's working wavelengths, generates a crosstalk phenomenon, consisting of the transmission of light beams between the source and the detector by optical reflection on the screen.

Thus, the first photodiode 121 can detect a first crosstalk signal XT_{N}, and the second photodiode 122 can detect a second crosstalk signal XT_{F}.

The crosstalk phenomenon, as well as ambient light, can have the drawback of degrading the performance of the proximity sensor, due to an undesirable optical component (noise) caused by light signals not emitted by the object, in addition to the useful optical reflection component caused by the reflection of the emitted light signal on the object.

Thus, in the example shown, the first signal DN_{N} from the first photodiode 121 is equal to:

$$D {N}_{N} = {S}_{N} + {A}_{N} + X {T}_{N} .$$

And the second signal DN_{F} from the second photodiode 122 is equal to:

$$D {N}_{F} = {S}_{F} + {A}_{F} + X {T}_{F} .$$

The ambient light component for each photodiode can be compensated for, for example in processing device 140, by acquiring source-off measurements, as only ambient light is then detected, followed by source-on measurements, and subtracting between the source-on generated signal and the source-off generated signal for each photodiode. This can be achieved by acquiring several measurement samples in each configuration (source off and source on).

Thus, if we manage to remove the ambient light component from the signals, what remains for the first photodiode 121:

$$D {N}_{N} = {S}_{N} + X {T}_{N} .$$

And for the second photodiode 122:

$$D {N}_{F} = {S}_{F} + X {T}_{F} .$$

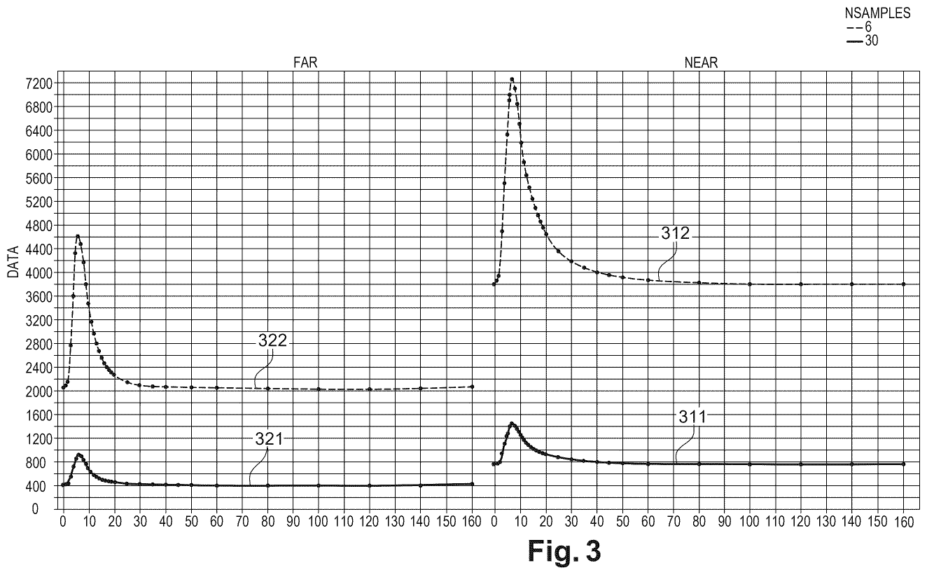

However, there remains the crosstalk component, which may explain why the proximity sensor 100, for example the processing device 140, may, based on the signals generated by the photodiodes 121, 122, not distinguish whether the object is at a very short distance, typically a few millimeters, or at a long distance, typically more than a few centimeters, as illustrated in FIG. 3.

FIG. 3 illustrates the curves showing the evolution of signals generated by the photodiodes of the proximity sensor 100 shown in FIG. 1 as a function of the distance (in mm) from the proximity sensor to an object, and for two different quantities of measurement samples. The signals generated are, for example, in the form of a number of counts.

The right-hand curves 311, 312 correspond to the signals generated by the first photodiode 121 (NEAR), while the left-hand curves 321, 322 correspond to the signals generated by the second photodiode 122 (FAR). The upper curves 312, 322 correspond to 30 measurement samples, and the lower curves 311, 321 correspond to 6 measurement samples. It can be seen that the level of each signal, whether for the first photodiode 121 or the second photodiode 122, is substantially the same whether the distance is less than 2 or 3 millimeters (very short distance) or higher than 30 or 40 millimeters (long distance), and that the number of samples makes no difference.

In the example application described in relation to FIGS. 2A and 2B, it is understood that this issue may compromise the triggering of screen switching-off when the user is very close to, or even stuck to, the screen and/or screen switching-on when the user is far from the screen.

In order to address this issue, it may be desired to suppress or reduce crosstalk components in the signals, for example by processing the first DN_{N} signal generated by the first photodiode 121 and the second DN_{F} signal generated by the second photodiode 122 differently. One solution may consist in applying a ratio between the first signal DN_{N} and the second signal DN_{F}, or between the second signal DN_{F} and the first signal DN_{N}. Another solution may consist in weighting the first signal DN_{N} by a coefficient α before subtracting from it the second signal DN_{F}, or in weighting the second signal DN_{F} by the coefficient α before subtracting from it the first signal DN_{N} and to test several values of the coefficient α to minimize or even eliminate crosstalk components in the signals.

The second solution may consist in implementing, for example in the processing device 140, or in a dedicated compensation unit, a compensation algorithm which allows the following compensation equation to be constructed:

$$D N = α \times ( {S}_{N} + X {T}_{N} ) - ( {S}_{F} + X {T}_{F} ) = ( α - β ) \times {S}_{N} ,$$

$$where$$

$${XT}_{F} = α \times X {T}_{N} ,$$

$$and$$

$${S}_{F} = β \times {S}_{N} .$$

Depending on the photodiode configuration, for example in the configuration shown in FIG. 1, there may be more crosstalk component on the photodiode FAR than on the photodiode NEAR, so that α is higher than 1.

Depending on the configuration of the photodiodes and/or the positioning of the object, or even other parameters such as sensor assembly parameters and/or light source characteristics, there may be more reflected signal detected on the photodiode NEAR than on the photodiode FAR, so that β is less than 1, or conversely there may be more reflected signal detected on the photodiode FAR than on the photodiode NEAR, so that β is higher than 1.

By playing with the coefficient α in the compensation equation, for example by applying several values to the coefficient α, it is possible to obtain an output signal DN with mainly the useful optical reflection component, i.e. an output signal DN free of crosstalk components, or at least with reduced crosstalk components. For example, at least four, or even at least eight, values of the a coefficient are required.

However, these solutions require a large number of calculations to be carried out, needing implementing logic circuits, which have a non-negligible surface footprint on the electronic device, and which consume electrical energy. Moreover, these solutions may require a minimum distance d1 between the two photodiodes in order to guarantee different signal behavior between the two photodiodes NEAR and FAR. Indeed, the higher the difference in the behavior of the two photodiodes NEAR and FAR, the better the detection. For example, the distance d1 is higher than 0.5 mm, or even higher than 1 mm, e.g. around 1.2 mm, which can further result in increasing the size of the electronic device.

The inventors propose a proximity capture device, i.e. a device comprising a proximity sensor, which makes it possible to overcome all or some of the disadvantages described above, in particular to solve the issue of discriminating between a very close object and a distant object, preferably with a solution that is simple to implement, for example, a solution that avoids increasing the size of the proximity capture device and consumes little electrical power.

Embodiments of proximity capture devices will be described below. The embodiments described are non-limiting and various variants will become apparent to the person skilled in the art from the indications of the present description.

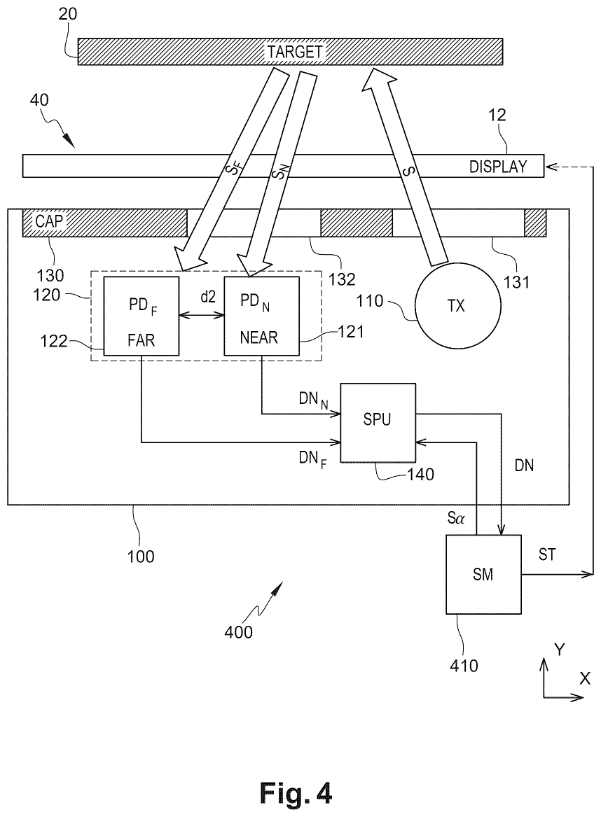

FIG. 4 illustrates a proximity capture device 400 according to one embodiment, included in an electronic device 40 and positioned under a wall 12 (DISPLAY) of the electronic device 40.

The proximity capture device 400 includes a proximity sensor which may be similar to the proximity sensor 100 shown in FIG. 1, which comprises a light source 110 and a light detector 120 including a first photodiode 121 (NEAR) and a second photodiode 122 (FAR) under a capping wall 130, such as a cap (CAP). In the example shown, the photodiodes are arranged side by side, and spaced apart by a second distance d2, in a direction X substantially parallel to the plane of the wall 130, but other configurations are possible. Wall 130 comprises two openings 131, 132, a first opening 131 in line with source 110 and a second opening 132 in line with detector 120, for example more particularly centered with first photodiode 121, second photodiode 122 being positioned substantially under an unopened portion of wall 130.

Each photodiode is adapted to detect a light signal S emitted by the source 110, then reflected S_{N}, S_{F} by an object 20 (TARGET). By detecting the reflected light signal, and generally spurious signals as described hereinafter, each photodiode is adapted to generate a signal DN_{N}, DN_{F}.

The proximity sensor 100 may also include, similar to the proximity sensor shown in FIG. 1, a processing device 140 (SPU) configured to process the signals generated by the detector 120, in the example shown the signals DN_{N}, DN_{F} generated by the two photodiodes 121, 122, for a proximity detection calculation. The processing device 140 can generate an output signal DN as a function of the signals DN_{N}, DN_{F}.

The proximity sensor 100 can be of the time-of-flight (ToF) type, in which case the processing device 140 can be configured to calculate the travel time between the emission of the light signal and its reception by the detector, and the distance from the object to the proximity sensor can then be deduced based on this travel time.

The proximity sensor 100 can operate with infrared (IR) or near infrared (NIR) light. For example, the proximity sensor 100 can operate at wavelengths in the non-visible spectrum, such as wavelengths above 850 nm.

Wall 12 can be a wall with low light transmittance, more generally a wall likely to generate a crosstalk phenomenon at the working wavelengths of proximity sensor 100, by reflection on said screen of the light signals emitted by light source 110 and transmitted to light detector 120. Wall 12 can be a display screen, for example an OLED-type display screen, a bezel, which is a non-display area in a border region of a display screen, or dark cover glass.

The proximity capture device 400 further comprises a control circuit 410 (SM), for example implemented by a state machine or a central processing unit (CPU).

Control circuit 410 is adapted to receive a signal from detector 120.

The control circuit 410 can be coupled to the detector 120 via the processing device 140, which can pre-process the signals DN_{N}, DN_{F} acquired by the two photodiodes, so that the control circuit 410 is adapted to recover the output signal DN.

The output signal DN is preferably obtained by weighting one of the first and second signals by the weighting coefficient α, for example by weighting the first signal DN_{N} from the first photodiode 121 by the coefficient α before subtracting from it the second signal DN_{F} from the second photodiode 122, or by weighting the second signal DN_{F} by the weighting coefficient α before subtracting from it the first signal DN_{N}.

The control circuit may be of the coprocessor type.

The control circuit 410 has been shown not as part of the proximity sensor 100, but as part of the proximity capture device 400 and coupled to the proximity sensor 100. This is not a limitation and other configurations are possible. According to a variant, the control circuit 410 may be included in the proximity sensor 100, for example in the processing device 140. According to another variant, the control circuit 410 can retrieve data from the proximity sensor 100 without necessarily being coupled to this sensor, and the retrieved data can be post-processed in the control circuit 410.

Note that the processing device 140 can be omitted in the proximity sensor shown in FIG. 3, and the signals generated by the two photodiodes can be routed directly to the control circuit 410 without being pre-processed.

The control circuit 410 is adapted to: trigger from a first state, in which the weighting coefficient has a first value α1, to a second state when the output signal DN crosses a first threshold; in the second state, apply to the weighting coefficient a second value α2 different from the first value α1; and compare the output signal DN obtained by applying the second value α2 with a second threshold.

For example, in the second state, the control circuit 410 sends to the processing device 140 a control signal Sα to modify the coefficient α, so as to modify the output signal DN.

For example, if the output signal DN is below the second threshold, then the control circuit triggers from the second state to a third state, and if the output signal DN is higher than or equal to the second threshold, then the control circuit triggers from the second state to a fourth state.

The control circuit 410 provides a status signal ST which is a function of the result of the comparison between the output signal and the second threshold, for example depending on whether the control circuit 410 is in the third state or the fourth state.

The status signal ST can be an analog or digital signal, a value in a readable status register, or both. The status signal ST can also be a variable in a program running the status machine.

The status signal ST may comprise a first value ST_{N} corresponding to an object at a first distance from the proximity sensor, and a second value ST_{F} corresponding to an object at a second distance from the proximity sensor, the second distance being higher than the first distance. The first distance can be a very short distance (very close object), typically a few millimeters, for example less than 2 or 3 millimeters. The second distance can be a long distance (distant object), typically more than a few centimeters, for example more than 20, 30, or even 40 millimeters.

The status signal ST can be transmitted to the display screen 12, or a control circuit of the display screen, for example in order to switch it off, or keep it off, if the status signal ST assumes the first value ST_{N}, or to switch it on, or keep it on, if the status signal ST assumes the second value ST_{F}.

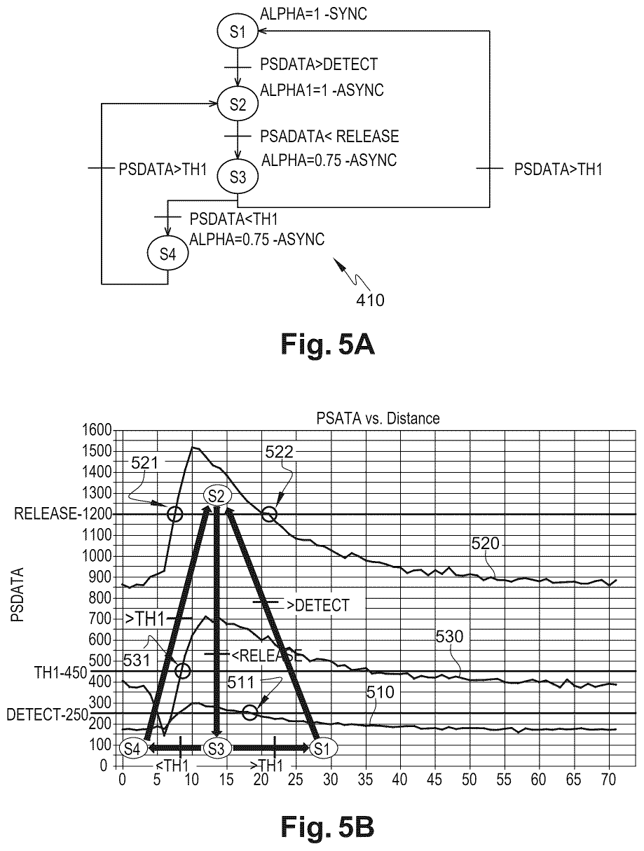

FIG. 5A illustrates an example embodiment of the control circuit 410 of the proximity capture device 400 shown in FIG. 4. The control circuit shown in FIG. 5A is implemented by a state machine. FIG. 5B illustrates an example of operation of the control circuit 410 shown in FIG. 5A.

The example shown in FIGS. 5A and 5B is described in relation to the application shown in FIGS. 2A and 2B, and can have several applications related to proximity detection under a low-transmittance screen or wall, for example in products such as smartphones, computers, tablet computers, headsets, virtual reality headsets.

The state machine shown comprises four states, and transitions between states: a state S1 (fourth state), in which the weighting coefficient has a first value α1, and the display is switched on (SYNC); a transition from state S1 to a state S2 (first state) if the output signal (PSDATA) rises above the detection threshold (DETECT), in state S2, the display is switched off (ASYNC); a transition from state S2 to state S3 (second state) if the output signal PSDATA falls below the release threshold (RELEASE); in state S3, the weighting coefficient assumes a second value α2 different from the first value; a transition from state S3 to state S4 (third state) if the output signal PSDATA falls below a threshold (TH1) (second threshold), and the display is still off (ASYNC); a transition from state S4 to state S2 if the output signal PSDATA rises again above threshold TH1; a transition from state S3 to state S1 (fourth state) if the output signal PSDATA is above threshold TH1, and the display is switched back on (SYNC).

We have shown a four-state state machine, but the state machine could have more than four states.

When the screen is switched on, the proximity sensor can synchronize itself with a screen clock, for example to match the times at which the light source emits the light signal with screen activity. This is known as synchronous mode (SYNC). When the screen is off, the proximity sensor can no longer synchronize with the screen clock. This is known as asynchronous mode (ASYNC).

As a non-limiting example, the first value α1 is equal to 1 and the second value α2 is equal to 0.75, but other values may be suitable.

In FIG. 5B, states, transitions and thresholds are shown in connection with curves showing the evolution of the proximity sensor output signal as a function of the distance from the object to the proximity sensor (in millimeters). The first curve 510 corresponds to an evolution of the output signal PSDATA when the weighting coefficient has the first value α1 and the display is switched on (first configuration). The second curve 520 corresponds to an evolution of the output signal PSDATA when the weighting coefficient has the first value α1 and the display is off: in this second configuration, the number of measurement samples can be higher than in the first configuration, for example to increase the signal-to-noise ratio, which explains why the threshold RELEASE is above the threshold DETECT in the example shown. The third curve 530 corresponds to an evolution of the output signal PSDATA when the weighting coefficient has the second value α2 and the display is off (third configuration).

In state S1, the proximity sensor output signal follows the first curve 510. It can be seen that as the distance decreases, in this example below around 18 mm (point 511), then the output signal PSDATA exceeds the detection threshold DETECT. The display then switches off, and we go to state S2.

In state S2, the proximity sensor output signal follows the second curve 520, while the screen is off. Starting from state S2, we can see that we can go below the release threshold RELEASE either when the distance decreases (point 521), or when the distance increases (point 522). We have then entered state S3 and are still following the second curve 520. In other words, the screen could turn back on as desired as the distance from the object to the sensor increases, but it could also turn back on as the distance from the object to the sensor decreases again, which is not desired. Thus, in state S2, or in state S3 following the second curve 520, the proximity sensor output signal does not indicate whether the object is moving away from or towards the sensor.

Therefore, in state S3, the weighting coefficient takes on a second value α2 different from the first value, so that the output signal PSDATA is modified. This second value α2 is preferably selected so as to make the output signal asymmetrical between a short distance and a long distance, and to be able to determine whether the object is at a short or long distance from the sensor. The output signal PSDATA then follows the third curve 530. In the example shown, if the output signal PSDATA is below the threshold TH1 (below point 531), then the state S4 is entered, and the display can remain switched off, and if the output signal PSDATA is above the threshold TH1, then the state S1 is entered and the display can be switched back on. In the example shown, threshold TH1 is between the thresholds DETECT and RELEASE, but this is not limiting. Alternatively, state S1 could be entered if the output signal PSDATA was below threshold TH1, and state S4 if the output signal PSDATA was above threshold TH1.

As can be seen from this example implementation, the embodiments allow the problem of discriminating between a very close object and a distant object to be solved with an easy-to-implement solution, for example a state machine with four states, three thresholds (two could suffice if we start from state S2), and two values of a weighting coefficient, and preferably with a displacement of the object or proximity sensor. Such a solution can meet the requisite to limit the size of a proximity capture device, and to limit electrical power consumption.

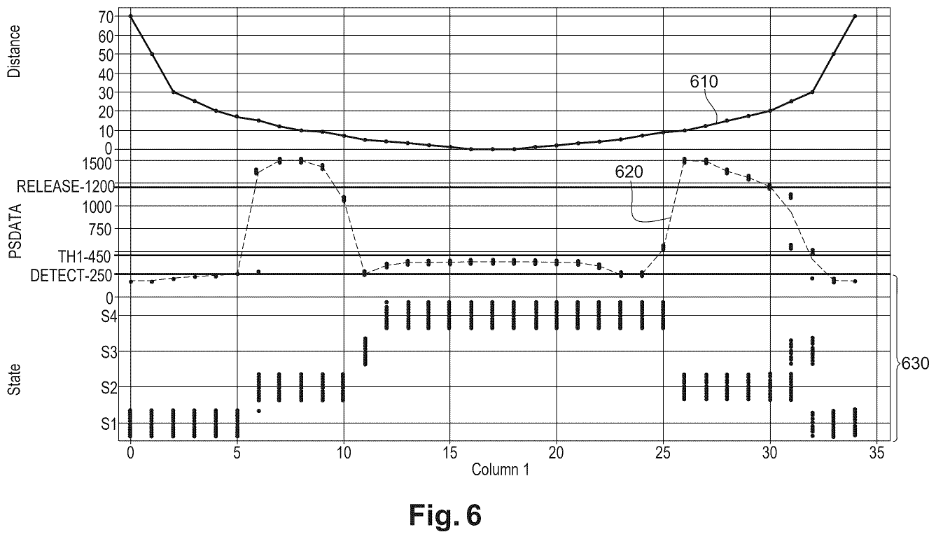

FIG. 6 illustrates a curve showing the evolution of the output signal from the proximity sensor 100 shown in FIG. 4, and the different states of the control circuit 410 shown in FIG. 5A as a function of the distance from the proximity sensor to an object.

The curve 610 in the upper part of FIG. 6 represents the distance from the object to the proximity sensor (Distance). The curve 620 in the middle part of FIG. 6 represents the curve showing the evolution of the output signal (PSDATA) of the proximity sensor 100. The lines 630 in the lower part of FIG. 6 represent the different states (state) of the control circuit 410. These lines correspond to several values of each state S1-S4, which explains the line shape rather than a single point.

FIG. 6 shows that when the output signal PSDATA is below the detection threshold DETECT, the control circuit is in the fourth state S1, and when the output signal PSDATA rises above the detection threshold DETECT, the control circuit is in the first state S2. In the example shown, the output signal PSDATA also rises above the release threshold RELEASE. Then, when the output signal PSDATA falls below the release threshold RELEASE, the control circuit enters the second state S3, in which the weighting coefficient changes from the first value α1 to the second value α2. The control circuit then compares the generated output signal with threshold TH1. If the output signal PSDATA is below threshold TH1, then the control circuit switches from the second state S3 to the third state S4. Although not shown, starting from S3, if the output signal PSDATA rises above threshold TH1, then the control circuit switches to the fourth state S1. If, starting from S4, the output signal PSDATA rises above threshold TH1 again, then the control circuit switches to the first state S2.

The embodiments allow the second distance d2 between the photodiodes shown in FIG. 4 to be smaller than the first distance d1 between the photodiodes shown in FIG. 1, e.g. the distance d2 can be less than 500 μm, e.g. around 250 μm.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

What is claimed is:

1. A proximity capture device comprising:
a proximity sensor comprising a light source and a light detector including at least one first photodiode configured to generate a first signal when it detects a first light signal emitted by the light source and reflected by an object, and one second photodiode configured to generate a second signal when it detects a second light signal emitted by the light source and reflected by the object, the proximity sensor being configured to deliver an output signal based on weighting, with a weighting coefficient, the first signal differently from the second signal; and
a control circuit configured to provide the weighting coefficient to the proximity sensor and receive the output signal, and to:
trigger from a first state in which the weighting coefficient has a first value, to a second state when the output signal crosses a first threshold;
in the second state, apply to the weighting coefficient α second value different from the first value; and
compare the output signal obtained by applying the second value and a second threshold so as to trigger from the second state to a third state if the output signal is less than the second threshold, or to trigger from the second state to a fourth state if the output signal is higher than the second threshold.

2. The device according to claim 1, wherein the third state corresponds to a first distance from the object to the proximity sensor, and the fourth state corresponds to a second distance from the object to the proximity sensor, the second distance being higher than the first distance, or the first distance being higher than the second distance.

3. The device according to claim 1, wherein the output signal is obtained by subtracting the second signal from the first signal weighted by the weighting coefficient.

4. The device according to claim 1, wherein the output signal is preprocessed by a processing device of the proximity sensor, the processing device being coupled with the control circuit.

5. The device according to claim 1, wherein the light source and the light detector are located under a capping wall of the proximity sensor.

6. The device according to claim 5, wherein the first and second photodiodes are disposed side by side, and spaced apart by a distance, along a direction parallel to a plane of the capping wall.

7. The device according to claim 5, wherein the capping wall includes a first opening located in line with the light source, and a second opening in line with the light detector, for example the second opening is centered on the first photodiode, the second photodiode being located under a non-opened part of the capping wall.

8. The device according to claim 1, wherein the first photodiode is located between the light source and the second photodiode.

9. The device according to claim 1, wherein the proximity sensor is under a wall being able to generate a crosstalk phenomenon by reflecting on wall light signals emitted by the light source then transferred towards the light detector.

10. The device according to claim 1, wherein the control circuit is configured to generate a state signal, the state signal comprising a first value in the third state and a second value in the fourth state.

11. The device according to claim 10, wherein the proximity sensor is under a display screen, and the state signal is configured to be transferred to the display screen, or to a control circuit of the display screen, so as to control its switching off or on, based on whether the state signal takes the first value or the second value.

12. A processing method of an output signal delivered by a proximity sensor, the method comprising:
detecting a first signal at a first photodiode of a light detector of the proximity sensor, the first signal being generated when light from a light source reflected from object;
detecting a second signal at a second photodiode of a light detector, the first signal being generated when light from the light source is reflected from the object;
calculating a first output signal based on weighting, with a weighting coefficient, the first signal differently from the second signal, the weighting coefficient having a first value;
triggering, at a control circuit, from a first state to a second state when the first output signal crosses a first threshold;
in the second state, applying to the weighting coefficient α second value different from the first value;
calculating a second output signal based on weighting, with the weighting coefficient having the second value, the first signal differently from the second signal; and
comparing the second output signal to a second threshold so as to trigger from the second state to a third state if the second output signal is less than the second threshold, or to trigger from the second state to a fourth state if the second output signal is higher than the second threshold.

13. The method according to claim 12, further comprising:
providing the second value of the weighting coefficient to the proximity sensor, wherein proximity sensor calculates the second output signal in response to receiving the second value.

14. The method according to claim 12, wherein the control circuit generates a state signal, the state signal comprising a first value in the third state and a second value in the fourth state.

15. The method according to claim 14, wherein the proximity sensor is under a display screen, and the state signal is transferred to the display screen, or to a control circuit of the display screen, so as to control its switching off or on, based on whether the state signal takes the first value or the second value.

16. The method according to claim 12, wherein the third state corresponds to a first distance from the object to the proximity sensor, and the fourth state corresponds to a second distance from the object to the proximity sensor, the second distance being higher than the first distance, or the first distance being higher than the second distance.

17. The method according to claim 12, wherein the second output signal is obtained by subtracting the second signal from the first signal weighted by the weighting coefficient.

18. The method according to claim 12, wherein the second output signal is preprocessed by a processing device of the proximity sensor, the processing device being coupled with the control circuit.

19. The method according to claim 12, wherein the light source and the light detector are located under a capping wall of the proximity sensor.

20. The method according to claim 19, wherein the first and second photodiodes are disposed side by side, and spaced apart by a distance, along a direction parallel to a plane of the capping wall.
